(19) United States
(12) Patent Application Publication
(10) Pub. No.: US 2026/0095051 A1
(43) Pub. Date: Apr. 2, 2026

(54) MULTIMODAL MICROGRID SYSTEM

(71) Applicant: Linkville Land Holdings LLC, Redmond, WA (US)

(72) Inventors: Nicholas Bair, Klamath Falls, OR (US); Cornelius Fitzgerald, San Rafael, CA (US); John Strawn, Orange, CA (US); Jerry Haugen, Klamath Falls, OR (US)

(73) Assignee: Linkville Land Holdings LLC, Redmond, WA (US)

(21) Appl. No.: 18/903,589

(22) Filed: Oct. 1, 2024

(51) Int. Cl. H02J 3/38; B01D 53/62; C25B 1/04; F25J 3/04; G06Q 10/0631; H02J 3/00

(52) U.S. Cl. CPC H02J 3/381; B01D 53/62; C25B 1/04; F25J 3/04; G06Q 10/06313; H02J 3/004; B01D 2257/504; H02J 2101/10; H02J 2101/24; H02J 2101/28; H02J 2101/40

(57) ABSTRACT

A microgrid system is disclosed that integrates two or more energy sources and molecule production. The system comprises two energy generators, a molecule producer, and a central controller. The primary generator harnesses one energy type, while the secondary taps another. These power the molecule unit's production process. The controller coordinates operations by gathering data from both generators and considering target molecule volumes. The system then adjusts the generators to optimize performance and meet production goals.

### TECHNICAL FIELD

The present disclosure relates to a multimodal microgrid system, and more particularly to a multimodal microgrid system that is configured to generate molecules such as hydrogen, nitrogen, oxygen, argon, etc. by using primarily onsite energy sources.

### BACKGROUND

An electrolysis unit generates hydrogen and oxygen by using water and electricity. Similarly, an air separation unit uses electricity to separate molecules such as oxygen and nitrogen from air. There are other known molecule generation units that use electricity to generate molecules such as argon, liquid CO2, etc. Such molecules are used in various application areas, e.g., as fuel or energy generation source in vehicles, rockets, airplanes, manufacturing units, etc., or as raw material in industries such as food, pharmaceutical, glass, wastewater processing, and/or the like.

In a conventional set-up, the electricity required to operate the molecule generation unit is obtained from utility power grid. Considerable cost may be incurred in operating the molecule generation unit by using grid power, especially at those times of the day when the grid power is expensive. As various power sources are available to generate the molecules and convert them to saleable forms (e.g. liquefaction), the system can take advantage of efficiency and cost savings. The relative cost and availability of various power sources may vary depending on environmental situation (solar radiation, wind speed, etc.) or power supplied or demanded by others (grid).

Thus, a system is required that enables molecule generation in an environment-friendly and cost-effective manner.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an environment in which techniques and structures for providing the systems and methods disclosed herein may be implemented.

FIG. 2 depicts a block diagram of an example microgrid system in accordance with the present disclosure.

FIG. 3 depicts a flow diagram of an example method for operating a microgrid system in accordance with the present disclosure.

### DETAILED DESCRIPTION

### Overview

The present disclosure describes a multimodal microgrid system (“system”) that is configured to generate/produce molecules such as hydrogen, oxygen, nitrogen, argon, CO2, etc. by using energy obtained primarily from system's onsite energy generation units. The system may include two or more onsite energy generation units that may be configured to generate energy by using energy sources such as wind, solar, geothermal, etc. and natural gas, and one or more molecule generation units that may produce molecules by using energy obtained from the onsite energy generation units. As an example, the system may include a first energy generation unit (e.g., a wind turbine or photovoltaic unit) that may generate energy from wind or solar energy, and a second energy generation unit (e.g., a gas turbine) that may generate energy from natural gas. The system may further include a CO2 capture unit configured to sequester or utilize CO2 for downstream purposes. Such purposes may include, for example, sustainable aviation fuel production, tertiary recovery, or carbonated beverage or additional energy production. Further, the system may include an electrolysis unit or other hydrogen producing systems, and an air separation unit that may produce oxygen, nitrogen, and argon, by using, for example, the energy obtained from the wind turbine, the photovoltaic unit, the gas turbine, and/or the like.

In some aspects, the system may be configured to control the operations of the first and second energy generation units and the flow of energy to the electrolysis unit and/or the air separation unit based on a plurality of parameters including, but not limited to, availability status of energy sources such as wind, solar, natural gas, etc., cost of operating the wind turbine, the photovoltaic unit, and/or the gas turbine, etc., and/or the like, a real-time market value of the molecules produced by the disclosed system, a desired minimum molecule output volume, and/or the like. The system may control the energy generation unit operation and the flow of energy in such a manner that the system may operate in a cost-effective, profitable and environment-friendly manner, while at the same time may maximize a desired minimum molecule output volume.

The system may utilize one or more energy resources to maximize its cost effective use given available resources day or night. For example, during daytime, the system may enable the photovoltaic unit to provide energy to the system for molecule production, as utilizing solar energy is environment-friendly and the cost of operating the photovoltaic unit may be considerably lower than the cost of operating the gas turbine. On the other hand, when the sunlight is not available, the system may cause the gas turbine to provide energy for molecule production, to maximize molecule output volume. Furthermore, adding an energy storage apparatus or mechanism to further reach desired output volumes which may be more cost effective. As an example, utilizing an electrostatic energy storage both to store hydrogen molecules and/or electrons to be utilized in the system. Whereas these mechanisms and tools may provide energy resiliency and security/continuity.

The system may further increase molecule production when economically advantageous. Furthermore, the system may ramp up energy production for continuity or energy resiliency. In this case, the system may cause the first and/or second energy generation units to provide additional energy to the system to ramp up production.

In further aspects, the system may be configured to also obtain power from publicly available sources such as the utility grid to produce molecules, when, e.g., wind or solar energy may not be available or limited, and the price of natural gas may be higher than the price of grid power. In further aspects, the system may be configured to enable transfer of energy stored in the energy storage unit to the grid. In this manner, the system facilitates in effectively monetizing energy generated by the system's onsite energy generation units, and/or provides energy resiliency/continuity.

The system may enable behind the meter/Inside the Battery Limit (BTM and ISBL) storage or production for system utilization, which may produce green molecules such as, for example, H2, CO2, O2, Argon, Nitrogen, sustainable aviation fuel, SAF, etc. The system may enable direct current (DC) generation.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

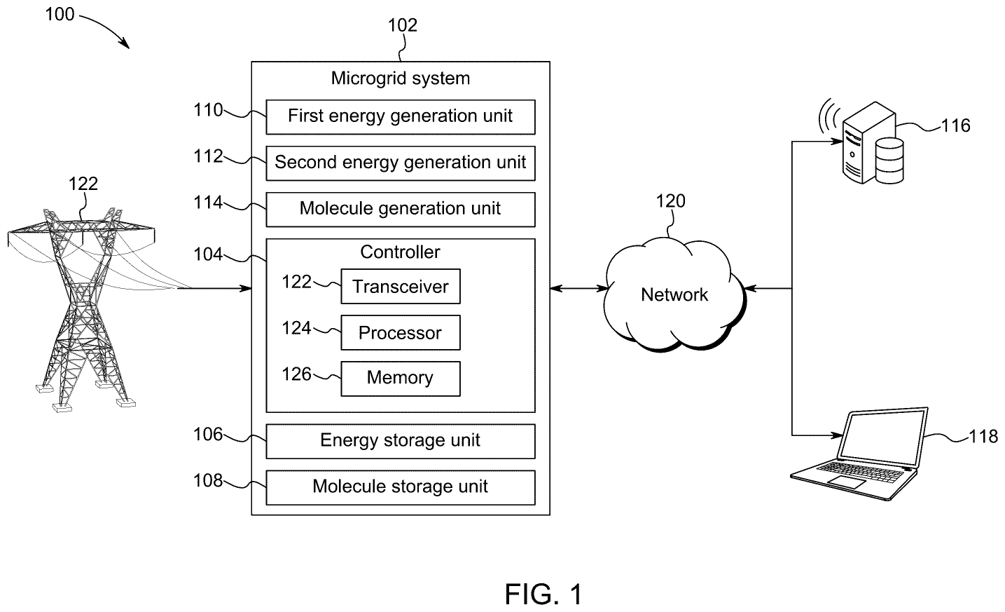

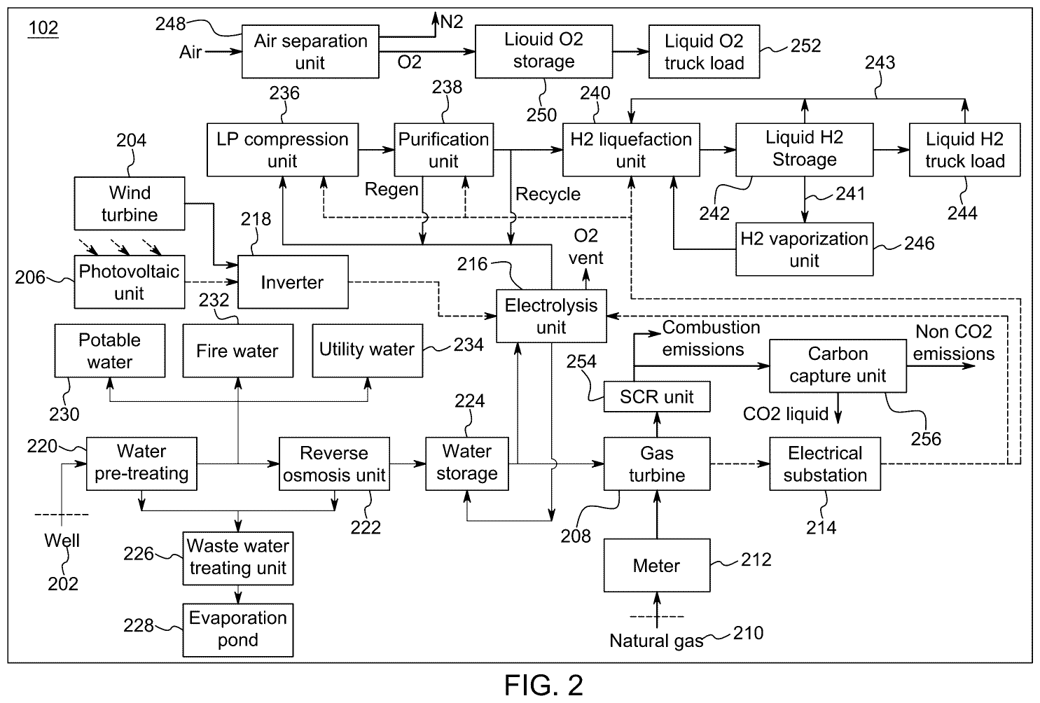

FIG. 1 depicts an environment 100 in which techniques and structures for providing the systems and methods disclosed herein may be implemented. FIG. 1 will be described in conjunction with FIG. 2.

The environment 100 may include a multimodal microgrid system 102 (or system 102) that may be configured to generate/produce molecules such hydrogen, nitrogen, oxygen, argon, CO2, etc. by using energy generated primarily via onsite energy sources (e.g., by energy sources that are part of the system 102 or located within the system boundary). Stated another way, the system 102 may utilize all available energy production sources thereby making the system 102 a self-sustaining energy production and/or storage system.

The system 102 may include a plurality of units/components/modules including, but not limited to, two or more onsite energy generation units, one or more molecule generation units, a controller 104, an energy storage unit 106, a molecule storage unit 108, an onsite water source or well 202 (as shown in FIG. 2), and/or the like. An example block diagram of the system 102 is shown in FIG. 1, and an example detailed schematic of the system 102 is shown in FIG. 2.

As described above, the system 102 may include two or more onsite energy generation units. In the example view depicted in FIG. 1, the system 102 is shown to include a first energy generation unit 110 and a second energy generation unit 112, although the system 102 may include additional energy generation units as well (e.g., third, fourth, fifth, etc. energy generation units, not shown). In an exemplary aspect, each onsite energy generation unit may be configured to generate energy by using a different energy source. For example, the first energy generation unit 110 may be configured to generate energy by using a first energy source, and the second energy generation unit 112 may be configured to generate energy by using a second energy source (which may be different from the first energy source). The controller 104 may synchronize the first and second energy sources, among others, to produce a predetermined threshold of energy production.

In an exemplary aspect, the first energy source may be a renewable energy source including, but not limited to, wind energy, tidal energy, solar energy, geothermal energy, electrostatic energy, molecular energy, etc. In this case, the first energy generation unit 110 may be, for example, a wind turbine 204 (as shown in FIG. 2), a photovoltaic unit 206, and/or the like. The wind turbine 204 may be configured to generate energy by using wind, when wind energy may be available, or wind may be blowing in the geographical area where the system 102 may be installed. Similarly, the photovoltaic unit 206 may be configured to generate energy by using solar energy, when sunlight may be available in the geographical area where the system 102 may be installed. In other exemplary aspects, the first energy source may be an energy source including at least one of an electrostatic storage device (that provides electrostatic energy), a grid delivered power, a wind power generator, a solar power generator, a geothermal power generator, a natural gas powered turbine power generator, a hydrogen and natural gas hydrogen blend powered turbine power generator, and/or the like.

Further, in an exemplary aspect, the second energy source may be natural gas. In this case, the second energy generation unit 112 may be, for example, a gas turbine 208 that may receive natural gas 210 via a meter 212 (which may be configured to control natural gas 210 consumption by the gas turbine 208, e.g., for billing and/or record-keeping purposes), and generate energy via an electrical substation 214. In other exemplary aspects, the second energy source may be least one of an electrostatic storage device, a grid delivered power, a wind power generator, a solar power generator, a geothermal power generator, a natural gas powered turbine power generator, a hydrogen and a natural gas hydrogen blend powered turbine power generator, and/or the like.

All the components/units described above may be part of the system 102 or installed within the system boundary, thereby enabling the system 102 to generate or control energy production.

In some aspects, the system's energy generation units described above (e.g., the wind turbine 204, the photovoltaic unit 206, the geothermal energy generation plant, the gas turbine 208, etc.) may all be controlled by the controller 104 to operate concurrently, or one or more units may operate at a time, based on the system's energy requirements or an amount of energy desired by a system operator to be generated, as described in detail later in the description below.

As described above, the controller 104 may cause the system 102 to include one or more molecule generation units. For example, as depicted in FIG. 1, the system 102 includes a single molecule generation unit 114. However, the present disclosure is not limited to such an aspect.

In an exemplary aspect, the molecule generation unit 114 may be an electrolysis array or an electrolysis unit 216 (as shown in FIG. 2, which may be, e.g., a Proton Exchange Membrane (PEM) type electrolyzer). The controller 104 may cause the electrolysis unit 216 to generate/produce molecules such as hydrogen and oxygen. A person ordinarily skilled in the art may appreciate that hydrogen molecules are commercially used in a plurality of industries/application areas including, but not limited to, automotive/transportation industry (as fuel), manufacturing, heating and cooking, aerospace industry, fertilizer industry, petroleum refinement industry, and/or the like. Therefore, the molecule generation unit 114 may be used to produce hydrogen or other molecules that may be commercially sold and used by the system operator.

In some aspects, the controller 104 may cause the molecule generation unit 114/electrolysis unit 216 to generate/produce hydrogen and oxygen by performing electrolysis on water obtained from the well 202 through multi-modal energy unit generation. The controller 104 may cause the molecule generation unit 114/electrolysis unit 216 to obtain energy required to perform the electrolysis from the first energy generation unit 110 and/or the second energy generation unit 112 described above. Stated another way, the molecule generation unit 114 may be configured to generate the molecules (e.g., hydrogen and oxygen) by using energy obtained from the first energy generation unit 110 and/or the second energy generation unit 112.

In the exemplary aspect depicted in FIG. 2, the controller 104 may cause the electrolysis unit 216 to obtain the energy generated by the wind turbine 204 and/or the photovoltaic unit 206 via an inverter 218. When the electrolysis unit 216 generates/produces hydrogen and oxygen by using energy obtained from the wind turbine 204 and/or the photovoltaic unit 206, hydrogen and oxygen are generated by using renewable energy sources, thereby ensuring that the process of producing hydrogen and oxygen is environment-friendly and cost-effective. A person ordinarily skilled in the art may appreciate that the cost of operating the wind turbine 204 and/or the photovoltaic unit 206 is substantially lower than obtaining energy generated via other sources (e.g., natural gas and/or the grid); therefore, producing hydrogen and oxygen by using energy generated by the wind turbine 204 and/or the photovoltaic unit 206 is highly cost-effective. Although upfront installation cost is associated with the wind turbine 204 and/or the photovoltaic unit 206; however, the long-term running/operating cost of these renewable energy generation units is substantially lower than the cost associated with using fossil-fuel based energy generation units.

In some aspects, when the amount of energy generated by the wind turbine 204 and/or the photovoltaic unit 206 may not be enough for the electrolysis unit 216 to generate a desired amount/volume of hydrogen (or oxygen), the controller 104 may instruct the electrolysis unit 216 to generate/produce hydrogen and oxygen by using energy obtained from the gas turbine 208 (via the electrical substation 214, as shown in FIG. 2). In this manner, the gas turbine 208 acts as back-up energy source for the electrolysis unit 216 when energy may not be generated by the wind turbine 204 and/or the photovoltaic unit 206, or the energy generated by these units may not be enough to generate the desired volume of hydrogen. As an example, when sunlight and/or wind are unavailable (or limited), the controller 104 may cause the gas turbine 208 to provide energy to the electrolysis unit 216 to generate hydrogen, to compensate for the loss of renewable energy. In this manner, the controller 104 instructs the electrolysis unit 216 to continuously generate/produce hydrogen and oxygen throughout the year (day and night).

The flow of energy to the electrolysis unit 216 from the energy generation units described above may be controlled by the controller 104 based on a plurality of different parameters, as described later in the description below.

As described above, the controller 104 causes the electrolysis unit 216 to perform electrolysis on the water obtained from the well 202 (or the onsite water source). Stated another way, the well 202 is configured to supply water to the electrolysis unit 216 to enable hydrogen and oxygen generation/production. In some aspects, the system 102 may include one or more additional units to ensure that the water extracted from the well 202 is properly treated before being fed to the electrolysis unit 216. As an example, the system 102 may include a water pre-treating unit 220, a reverse osmosis (RO) unit 222, and a water storage 224. The water pre-treating unit 220 may obtain the water from the well 202 and treat the water to remove impurities. The water output from the water pre-treating unit 220 may be fed into the RO unit 222, which may perform reverse osmosis on the water to further purify the water. The water output from the RO unit 222 may then be fed to the water storage 224, which may provide water to different system units such as the electrolysis unit 216, the gas turbine 208, and/or the like. In some aspects, the water not converted into hydrogen and oxygen by the electrolysis unit 216 may be fed back to the water storage 224, as shown in FIG. 2.

In some aspects, the system 102 may include additional units that may assist in efficient usage of water that is extracted from the well 202. For example, the system 102 may include a wastewater treating unit 226 that may receive effluent from the water pre-treating unit 220 and RO reject water from the RO unit 222, and treat the received water. The wastewater treating unit 226 may then output the treated water to an evaporation pond 228 (that may be located within the system boundary, and be part of the system 102).

In additional aspects, the water output from the water pre-treating unit 220 may be used as potable water 230, fire water 232, and/or fed to utility water source 234, as shown in FIG. 2. In this manner, the system 102 ensures that the water extracted from the well 202 is optimally used in different application areas, thereby preventing water wastage.

In further aspects, the controller 104 may instruct the system 102 to include one or more additional units and facilitate optimized hydrogen generation by the electrolysis unit 216 that may be optimally stored for commercial usage and/or transportation. For example, as shown in FIG. 2, the system 102 may include a low pressure (LP) compression unit 236, a purification unit 238, an H2 liquefaction unit 240, and a liquid H2 storage 242. In some aspects, the hydrogen generated/produced by the electrolysis unit 216 may be fed to the low pressure compression unit 236 that may be configured to compress the received hydrogen (while the oxygen generated by the electrolysis unit 216 may be outputted to the ambient environment via vents). The compressed hydrogen may then be fed to the purification unit 238 that may purify (i.e., remove impurities from) the hydrogen.

The hydrogen output from the purification unit 238 may be fed to the H2 liquefaction unit 240 that may liquefy the hydrogen, which may finally be fed to the liquid H2 storage 242. The liquid H2 storage 242 may be an example of the molecule storage unit 108 shown in FIG. 1. In some aspects, the molecule storage unit 108 may be configured to store the molecule (i.e., hydrogen) generated by the molecule generation unit 114 (i.e., the electrolysis unit 216).

The liquid hydrogen stored in the liquid H2 storage 242 may be transported for commercial usage via trucks or other transportation means (shown as liquid H2 truck load 244 in FIG. 2). Further, the controller 104 may utilize one or more feedback loops 241, 243 between the liquid H2 storage 242 and the H2 liquefaction unit 240 (via an H2 vaporization unit 246), and between the liquid H2 truck load 244 and the H2 liquefaction unit 240, which may enable unused hydrogen to be fed back to the H2 liquefaction unit 240. A similar feedback loop may exist between the purification unit 238 and the low pressure compression unit 236.

Although the description above describes an aspect where the system 102 includes the electrolysis unit 216 that generates/produces hydrogen for commercial usage, the present disclosure is not limited to such an aspect. In some aspects, the system 102 may additionally include more types of molecule generation units that may enable the system 102 to generate other types of molecules by using energy obtained from the energy generation units described above (i.e., the wind turbine 204, the photovoltaic unit 206, the gas turbine 208, and/or the like).

For example, the system 102 may additionally include an air separation unit 248 (as another example of the molecule generation unit 114) that may be configured to generate oxygen, nitrogen, and argon from air. The air separation unit 248 may obtain the energy required for operation from the system's energy generation units described above (i.e., the wind turbine 204, the photovoltaic unit 206, the gas turbine 208, and/or the like). In this manner, the system's energy generation units that provide energy for operation to the electrolysis unit 216 may also provide energy to the air separation unit 248.

In some aspects, the molecule generation unit 114 may additionally be an air carbon capture device configured to separate CO2 from a natural gas power generator.

The oxygen generated by the air separation unit 248 may be fed to a liquid O2 storage 250 (which may be an example of the molecule storage unit 108), which may be used to provide oxygen for commercial usage, e.g., via a liquid O2 truck load 252 (as shown in FIG. 2).

The system 102 may additionally include a Selective Catalytic Reduction (SCR) unit 254 and a carbon capture unit 256 that may be configured to generate liquid CO2. Specifically, the SCR unit 254 may receive flue gases from the gas turbine 208. The output from the SCR unit 254 may be fed to the carbon capture unit 256 (while combustion emissions may be output to the ambient environment), which may produce liquid CO2 from the output received from the SCR unit 254 (while non-CO2 emissions may be output to the ambient environment). The liquid CO2 may then be used or transported for commercial usage.

As described above, the system 102 may additionally include the controller 104. The controller 104 may be configured to control operation of the various system units described above. The controller 104 (and one or more other system units) may be communicatively coupled with one or more servers 116, one or more computing devices or user devices 118, and/or the like via one or more networks 120. The network 120, as described herein, may be, for example, a communication infrastructure in which the connected devices discussed in various embodiments of this disclosure may communicate. The network 120 may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, Ultra-wideband (UWB), and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples.

In addition to being communicatively coupled with the server 116 and the user device 118, the controller 104 may also be communicatively coupled with one or more system units, e.g., the wind turbine 204, the photovoltaic unit 206, the gas turbine 208, the electrolysis unit 216, the air separation unit 248, and/or the like (or the computing systems associated with these units) via the network 120. The controller 104 may be configured to receive information/inputs/data from one or more of these units and transmit command signals to control their operation. In an exemplary aspect, the controller 104 may include a transceiver 122, a processor 124 and a memory 126.

The transceiver 122 may be configured to transmit/receive information/data/signals to/from one or more system units, the server 116, the user device 118, and/or the like, via the network 120. For example, the transceiver 122 may receive information (e.g., a “first information”) associated with the first energy generation unit 110 (e.g., the wind turbine 204, the photovoltaic unit 206, etc.) and information (e.g., a “second information”) associated with the second energy generation unit 112 (e.g., the gas turbine 208) from the server 116, the user device 118 (which may be associated with, e.g., the system operator), and/or one or more computing devices associated with the first and second energy generation units 110, 112. The first information may include a first real-time information, a first prediction or forecast information, and/or a first historical information associated with the first energy generation unit 110 and/or the first energy source. The second information may include a second real-time information, a second prediction or forecast information, and/or a second historical information associated with the second energy generation unit 112 and/or the second energy source. Accordingly, the controller 104 may utilize the first information and/or the second information to balance energy production and optimize production capabilities as described herein.

In an exemplary aspect, the first real-time information may include information associated with real-time availability status of the first energy source and/or a real-time cost required to operate the first energy generation unit 110. As an example, when the first energy generation unit 110 is the wind turbine 204 or the photovoltaic unit 206, the first real-time information may include information associated real-time availability status of wind or solar energy (i.e., whether wind is blowing, or sunlight is available in the area where the system 102 is installed). Further, in this case, the real-time cost required to operate the first energy generation unit 110 may be the real-time cost (which may be marginal or less) that may be required to operate the wind turbine 204 or the photovoltaic unit 206. In some aspects, such cost may include the cost of operation, as well as the cost of regular maintenance, repair, etc.

Further, the controller 104 may incorporate and utilize the first historical information that may further include information associated with a historical availability status associated with the first energy source and/or a historical cost required to operate the first energy generation unit 110. As an example, when the first energy generation unit 110 is the wind turbine 204 or the photovoltaic unit 206, the historical availability status may indicate historical availability status of wind or solar energy at different times of the day, month, year, weather conditions, and/or the like. Further, the information associated with the historical cost may include information that indicates historical cost for kilowatt hours per time of operating the wind turbine 204 or the photovoltaic unit 206 at different times of the day, month, year, weather conditions, and/or the like.

Further, the controller 104 may incorporate and utilize prediction or forecast information that may include predictive analytics that may include publicly available information associated with weather information, market pricing information, energy demand information, current event information such as, for example, national or international conflict information, energy demand information, and/or geopolitical considerations, among other publicly available information. In some aspects the prediction or forecast information may include forecasts made by one or more third parties and publicly available to the system.

In some aspects, the first forecast information may be associated with predicted future information (related to availability and/or cost) associated with the first energy source and/or the first energy generation unit 110 determined based on one or more of the weather information, the market pricing information, the energy demand information, the current event information, and/or the like. In a similar manner, the second forecast information may be associated with predicted future information associated with the second energy source and/or the second energy generation unit 112 determined based on one or more of the weather information, the market pricing information, the energy demand information, the current event information, and/or the like.

In other aspects, the controller 104 may incorporate and utilize the prediction or forecast information. The first and second information may further include non-public information known only to managers of the disclosed system. For example, the prediction or forecast information may include scheduled maintenance or shutdown, observed plant efficiency and performance, predicted outages due to known or suspected sources of said shutdown, or other operational events. Furthermore, the transportation and delivery via energy resource infrastructure may be routinely known by system managers, and thus, the dynamic demands and predicted changes in production may be known. Accordingly, the system may receive user supplied planning and predictive information for the scheduled energy production. The system will accommodate logistics management such as energy transportation and last mile delivery.

In a similar manner, the second real-time information may include information associated with real-time availability status of the second energy source and/or a real-time cost required to operate the second energy generation unit 112. As an example, when the second energy generation unit 112 is the gas turbine 208, the second real-time information may include information associated real-time availability status of natural gas (which may be 100%, unless there is disruption in natural gas supply due to natural or man-made reasons). Further, in this case, the real-time cost required to operate the second energy generation unit 112 may be the real-time cost that may be required to operate the gas turbine 208 and purchase the natural gas. In some aspects, the cost to operate the gas turbine 208 may be much higher than the cost to operate the wind turbine 204 or the photovoltaic unit 206, as cost may be incurred in purchasing the natural gas, while wind or solar energy is free. For example, controller 104 may utilize current operational and predictive operations information, e.g., equipment useful life information and/or degradation information, etc. to optimize system efficiency and performance.

Further, the controller 104 may incorporate and utilize the second historical information. The second historical information may further include information associated with a historical availability status of the second energy source and/or a historical cost required to operate the second energy generation unit 112. As an example, when the second energy generation unit 112 is the gas turbine 208, the historical availability status may indicate historical availability status of natural gas at different times of the day, month, year, weather conditions, and/or the like. Further, the information associated with the historical cost may include information that indicates historical cost of operating the gas turbine 208 and/or the pricing of natural gas at different times of the day, month, year, weather conditions, and/or the like.

The controller 104 may cause the transceiver 122 to transmit the first and second information described above to the processor 124 for processing, and/or to the memory 126 for storage purpose. In some aspects, the transceiver 122 may be further configured to receive information associated a desired minimum output volume of the molecule that the molecule generation unit 114 should generate/produce (e.g., each day) from the system operator via the server 116 and/or the user device 118. The minimum output volume may indicate a minimum molecule volume that should be produced by the system 102 on each day (as desired by the system operator), irrespective of the availability status of one or more energy sources described above. For example, the system operator may indicate in the desired minimum output volume that 32 tons of hydrogen (or any other molecule described above) should be generated each day by the system 102, irrespective of whether renewable energy sources are available or not in the area where the system 102 is installed.

Similar to the first and second information described above, the controller 104 may further cause the transceiver 122 to transmit the information associated with the desired minimum output volume to the processor 124 and/or to the memory 126.

Further, the memory 126 may store programs in code and/or store data for performing various controller operations in accordance with the present disclosure. Specifically, the processor 124 may be configured and/or programmed to execute computer-executable instructions stored in the memory 126 for performing various controller functions in accordance with the disclosure. Consequently, the memory 126 may be used for storing code and/or data code and/or data for performing operations in accordance with the present disclosure.

In one or more aspects, the processor 124 may be in communication with one or more memory devices (e.g., the memory 126 and/or one or more external databases (not shown in FIG. 1). The memory 126 may include any one or a combination of volatile memory elements (e.g., dynamic random-access memory (DRAM), synchronous dynamic random access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

The memory 126 may be one example of a non-transitory computer-readable medium and may be used to store programs in code and/or to store data for performing various operations in accordance with the present disclosure. The instructions in the memory 126 may include one or more separate programs, each of which may include an ordered listing of computer-executable instructions for implementing logical functions.

In operation, the processor 124 may be configured to obtain the first information, the second information and the information associated with the desired minimum output volume of the molecule and/or electronic state directly from the transceiver 122 (as described above) or the memory 126. Responsive to obtaining the information described above, the processor 124 may predict a first availability status associated with the first energy source and a first cost required to operate the first energy generation unit 110 based on the first information. For example, the processor 124 may predict the availability status of wind or solar energy for the next 6/12/18/24 hours, and the cost to operate the wind turbine 204 or the photovoltaic unit 206 (when the first energy generation unit 110 is the wind turbine 204 or the photovoltaic unit 206) in the same time duration, based on the first information.

In a similar manner, the processor 124 may predict a second availability status associated with the second energy source and a second cost required to operate the second energy generation unit 112 based on the second information. For example, the processor 124 may predict the availability status of natural gas for the next 6/12/18/24 hours (which may be 100% in normal circumstances), and the cost to operate the gas turbine 208 (when the second energy generation unit 112 is the gas turbine 208) in the same time duration, based on the second information.

The processor 124 may then control (e.g., by transmitting command signals) a first energy generation unit operation and a second energy generation unit operation based on the first availability status, the first cost, the second availability status, the second cost and/or the desired minimum output volume. Specifically, the processor 124 may control the operation of the first and second energy generation units 110, 112 to ensure that the molecule generation unit 114 receives an optimal amount of energy, such that the molecule is generated by the molecule generation unit 114 in a cost-effective or economic manner, while at the same time ensuring that the volume of generated molecule is not below the desired minimum output volume. One or more example processes followed by the processor 124 to control the first and/or second energy generation unit operations are described below.

In an exemplary aspect, responsive to determining the first availability status, the processor 124 may first determine whether the first energy source availability is enough for the first energy generation unit 110 (e.g., the wind turbine 204 and/or the photovoltaic unit 206) to power the molecule generation unit 114 and generate the molecule at a volume greater than or equivalent to the desired minimum output volume. For example, if 150 MW of power/energy is required by the molecule generation unit 114 to generate the molecule at the desired minimum output volume, the processor 124 may first determine whether enough renewable energy source (i.e., the first energy source) is available that may enable the first energy generation unit 110 to generate 150 MW of power. If enough renewable energy source is available, the processor 124 may transmit a command signal to the first energy generation unit 110 to power the molecule generation unit 114.

On the other hand, if the processor 124 determines that enough availability of the first energy source (e.g., the renewable energy source) is not there for the first energy generation unit 110 to single-handedly power the molecule generation unit 114 (and produce the molecule at the desired minimum output volume), the processor 124 may activate or ramp-up operation of the second energy generation unit 112 to augment the power that is supplied to the molecule generation unit 114. Specifically, in this case, the processor 124 may estimate/determine an optimal first energy portion to be transferred to the molecule generation unit 114 via the first energy generation unit 110 and an optimal second energy portion to be transferred to the molecule generation unit 114 via the second energy generation unit 112, based on the first information, the second information and the desired minimum output volume described above. For example, if the molecule generation unit 114 requires 150 MW of power to generate the molecule at the desired minimum output volume and the first energy generation unit 110 can only provide 100 MW (i.e., the “optimal first energy portion”, determined based on the first information described above), the processor 124 may determine that the second energy generation unit 112 may be required to provide the remaining 50 MW of power (i.e., the “optimal second energy portion”) to the molecule generation unit 114. The processor 124 may then transmit command signals to the first energy generation unit 110 and the second energy generation unit 112 to control the first energy generation unit operation and the second energy generation unit operation based on the determined optimal first energy portion and the optimal second energy portion.

In some aspects, the processor 124 determines the optimal first energy portion and the optimal second energy portion to minimize the cost of operating the system 102 and enable the molecule generation unit 114 to generate the desired minimum molecule output volume. For example, in some aspects, the processor 124 may ensure that the maximum available power from the first energy generation unit 110 is provided to the molecule generation unit 114 (e.g., 100 MW described above; and not less than 100 MW), so that the system 102 is operated in an economical manner, as providing power to the molecule generation unit 114 from the second energy generation unit 112 may be costlier than providing power from the first energy generation unit 110. Therefore, the processor 124 may maximize (as much as possible) the transfer of power from the first energy generation unit 110 to the molecule generation unit 114 to optimize cost of operating the system 102 to generate the molecule(s).

In some aspects, the processor 124 may control the first energy generation unit operation and the second energy generation unit operation by activating or deactivating the first energy generation unit 110 and/or the second energy generation unit 112, and/or by ramping up or ramping down a flow of energy from the first energy generation unit 110 and/or the second energy generation unit 112 to the molecule generation unit 114. To control the unit operation as described above, the processor 124 may continuously estimate the first availability status, the first cost, the second availability status and the second cost at a predefined frequency (e.g., every 10-15 minutes, every 10 seconds, every 1 second, etc.) throughout the day based on the first and second information described above, and may dynamically activate/deactivate and/or ramp up/ramp down operation of the first energy generation unit 110 and/or the second energy generation unit 112 to ensure cost-effective and sustainable system operation and molecule production.

For example, since the availability of solar energy is limited during nighttime, the processor 124 may activate the gas turbine 208 to provide power to the molecule generation unit 114 to produce the desire amount of molecule during nighttime (e.g., when the wind energy is also not available). As the sunlight gradually becomes available through the day, the processor 124 may ramp down the gas turbine 208 operation and ramp up the photovoltaic unit 206 operation (i.e., ramp up the flow of energy from the photovoltaic unit 206 to the molecule generation unit 114), utilize and/or store some or all produced energy via an electrostatic energy storage (not shown in FIG. 1) to provide the required power to the molecule generation unit 114.

Although the description above describes an aspect where the processor 124 controls the first and second energy generation unit operations to operate the system 102 based on the availability status of energy sources and/or the cost of operating the first and second energy generation units 110, 112, the present disclosure is not limited to such an aspect. Additionally, the processor 124 may obtain a real-time molecule sale price associated with the molecule (e.g., hydrogen, oxygen, nitrogen, argon, etc.) produced by the molecule generation unit 114 from the server 116 and/or the user device 118 and may control the first energy generation unit 110 operation and the second energy generation unit 112 operation based on the real-time molecule sale price. For example, the processor 124 may ramp up the flow of energy from the first and/or second energy generation units 110, 112 to the electrolysis unit 216, to cause the electrolysis unit 216 to ramp up the production of hydrogen when the real-time hydrogen sale price may be high. Similarly, the processor 124 may ramp up the flow of energy from the first and/or second energy generation units 110, 112 to the air separation unit 248, to cause the air separation unit 248 to ramp up the production of oxygen when the real-time oxygen sale price may be high. In this case, the processor 124 may additionally transmit command signals to the electrolysis unit 216 and/or the air separation unit 248 to cause these units to ramp up their respective operations/outputs.

In the example described above, the processor 124 may control the first and second energy generation unit operations such that the molecules are produced by the system 102 in the most profitable and cost-effective manner (and also in a manner that is environment-friendly). In one aspect, for example, the processor 124 may calculate carbon intensity projections or measured values for energy production activities planned or realized. As another example, if 150 MW is required to generate the desired minimum hydrogen volume and the first energy generation unit 110 is capable of generating 250 MW of power, and the real-time oxygen sale price is higher than the real-time hydrogen sale price, the processor 124 may cause the first energy generation unit 110 to provide the excess 100 MW power to the air separation unit 248 to ramp-up the production of oxygen. In this case, the processor 124 may cause the second energy generation unit 112 to provide additional power to the air separation unit 248 only if it is necessary for further oxygen production (as cost is incurred in operating the second energy generation unit 112 via natural gas). If the cost of operating the second energy generation unit 112 may be higher than the gains obtained from the higher oxygen sale price, the processor 124 may not cause the second energy generation unit 112 to provide additional energy to the air separation unit 248 (as then the higher production of oxygen via the power obtained from the second energy generation unit 112 becomes unprofitable).

Although the description above describes an aspect where the molecule generation unit 114 generates molecules by using the energy obtained from the first and/or the second energy generation units 110, 112, the present disclosure is not limited to such an aspect. In some aspects, the system 102 may be additionally configured to obtain grid power from utility grid 128, as shown in FIG. 1. In this case, in addition to being able to generate the molecules by using the energy obtained from the first and/or the second energy generation units 110, 112, the molecule generation unit 114 (e.g., the electrolysis unit 216, the air separation unit 248, and/or the like) may be configured to generate the molecules by using the grid power obtained from the utility grid 128.

In some aspects, the processor 124 may control a flow of grid power to the molecule generation unit 114 based on a plurality of parameters including, but not limited to, a purchase cost associated with the grid power, a natural gas purchase price, the availability statuses of first and second energy sources, cost of operating the first and/or second energy generation units 110, 112, the molecule sale price, and/or the like. In this case, the processor 124 may first determine/obtain the grid power purchase cost/price from the server 116 and/or a computing device (not shown) associated with the utility grid 128, and then correlate the grid power purchase price with the natural gas purchase price, the availability statuses of first and second energy sources, cost of operating the first and/or second energy generation units 110, 112, and/or the like, to control the flow of grid power to the molecule generation unit 114, such that the molecules are generated in the most cost-effective/economical manner.

As an example, when the availability of the first energy source (i.e., the renewable energy source) may be limited and the natural gas purchase price may be greater than the grid power purchase price, the processor 124 may cause the molecule generation unit 114 to operate via the grid power (as opposed to the energy obtained from the second energy generation unit 112), to optimize the cost of operating the molecule generation unit 114. As another example, if the real-time molecule sale price is high and the output associated with the molecule generation unit 114 needs to be ramped-up, the processor 124 may cause the molecule generation unit 114 to obtain additional power from the utility grid 128 to ramp-up the molecule output (e.g., when the gains from the higher molecule sale price is greater than the cost incurred in using the grid power).

As described above, the system 102 may additionally include the energy storage unit 106. The energy storage unit 106 may be configured to store excess energy generated by the first energy generation unit 110 and/or the second energy generation unit 112. As an example, if 150 MW is required by the electrolysis unit 216 to generate the desired minimum amount of hydrogen and the first energy generation unit 110 (i.e., the wind turbine 204 and/or the photovoltaic unit 206) generates 250 MW, the excess 100 MW may be stored in the energy storage unit 106.

In one example the system 102 may produce, utilize, and/or store energy in either electrostatic state or molecular state (e.g., hydrogen), based on market or other realized or predicted demands. For example, the controller 104 and/or the processor 124 may determine and/or dynamically control, based on one or more of grid pricing, molecule market information, realized and/or predicted costs, etc., a relative mixture of energy production and/or storage in the form of molecule and/or electrostatic energy storage, i.e., utilizing hydrogen as a transportation fuel or utilizing hydrogen to supplement and or blend with natural gas to power turbine energy production for power generation sales.

The energy stored in the energy storage unit 106 may be used to power different system components such as lights, a heating ventilation air conditioning (HVAC) system, security system, and/or the like. Further, in some aspects, the processor 124 may cause the molecule generation unit 114 to generate the molecules by using the energy obtained from the energy storage unit 106 when, e.g., the first energy source may not be available or may be limited, and the natural gas price may be high. In some aspects, when the energy storage unit 106 has enough stored energy (e.g., greater than a predefined threshold), the processor 124 may prioritize use of energy stored in the energy storage unit 106 to produce the molecules as opposed to using the second energy generation unit 112 (e.g., when the first energy source may not be available or may be limited), as operating the molecule generation unit 114 by using the energy obtained from the second energy generation unit 112 is not environment-friendly and is less economical.

In some aspects, the energy storage unit 106 may be the electrostatic energy storage unit or supercapacitor that may be based on graphene-based supercapacitor technology. This may mitigate disadvantages of solar power production for example, with storage of excess solar energy generation up to 30 days or more. For example, the energy storage unit 106 may smooth out generation between ramp up, peak, and ramp down generation of solar capacity. The energy storage unit 106 further enables pushing output onto the utility grid 128 (as described below) even after sundown. The energy storage unit 106 enables real-time reaction to grid demands with a battery “buffer”. The energy storage unit 106 has the ability to take DC power generation by solar panels directly to maximum power point tracking (MPPT) devices and common DC bus, without the need for energy servers, and to inverters to convert to alternating current (AC) for upload to the grid. The energy storage unit 106 (e.g., the electrostatic energy storage or supercapacitor) has a modular design, where initial storage capacity can be expanded to match excess energy generation as solar capacity grows or additional energy generation projects come online. The energy storage unit 106 provides an attractive environmentally friendly alternative to lithium battery energy storage, which avoids use of rare earth minerals, reduces fire risk, and offers significantly longer storage up to 30, 40 50, etc. hours.

In further aspects, the processor 124 may be configured to enable a flow of stored or excess energy from the energy storage unit 106 to the utility grid 128 when, e.g., a real-time energy sale price to the utility grid 128 may be high (e.g., greater than a predefined price threshold). In this case, the processor 124 may continuously monitor the real-time energy sale price based on the inputs obtained from the server 116 and/or the computing device associated with the utility grid 128 and may cause the flow of stored or excess energy from the energy storage unit 106 to the utility grid 128 when the real-time energy sale price may be high. In some aspects, in addition to controlling the flow of stored energy from the energy storage unit 106 to the utility grid 128, the processor 124 may control the first and/or second energy generation unit operations based on the real-time energy sale price. As an example, when the real-time energy sale price may be high and it may be more profitable to sell the energy stored in the energy storage unit 106 to the utility grid 128, the processor 124 may activate the second energy generation unit 112 and cause the molecule generation unit 114 to generate molecules by using the energy obtained from second energy generation unit 112 (as opposed to using the energy stored in the energy storage unit 106). In this manner, the processor 124 may control the operations of the first and/or second energy generation units 110, 112 based on the real-time energy sale price such that the system 102 operates in the most economical manner.

Although the description above describes an aspect where the first energy generation unit 110, the second energy generation unit 112 and/or the energy storage unit 106 provide energy/power to the molecule generation unit 114, the present disclosure is not limited to such an aspect. In some aspects, the first energy generation unit 110, the second energy generation unit 112 and/or the energy storage unit 106 may also be used to provide energy/power to other system components/equipment such as lights, HVAC system, security system, the low pressure compression unit 236, the purification unit 238, the H2 liquefaction unit 240, the water pre-treating unit 220, the RO unit 222, the waste water treating unit 226, and/or the like, thereby making the system 102 a self-sustaining system that may not require external energy (e.g., from the utility grid 128) to operate.

It may be appreciated that the system 102 enables behind the meter/Inside the Battery Limit (BTM and ISBL) energy storage for complex utilization to produce molecules (H2, CO2,O2, Argon, Nitrogen, etc. sustainable aviation fuel, SAF). The system 102 enables reliable energy generation with battery energy storage including DC to DC from renewable and/or nonrenewable generation, grid low peak cost and storage capability that allows lowest cost and reliable (steady state) energy generation to battery storage to Production Facility (RO, Electrolyzers, etc.).

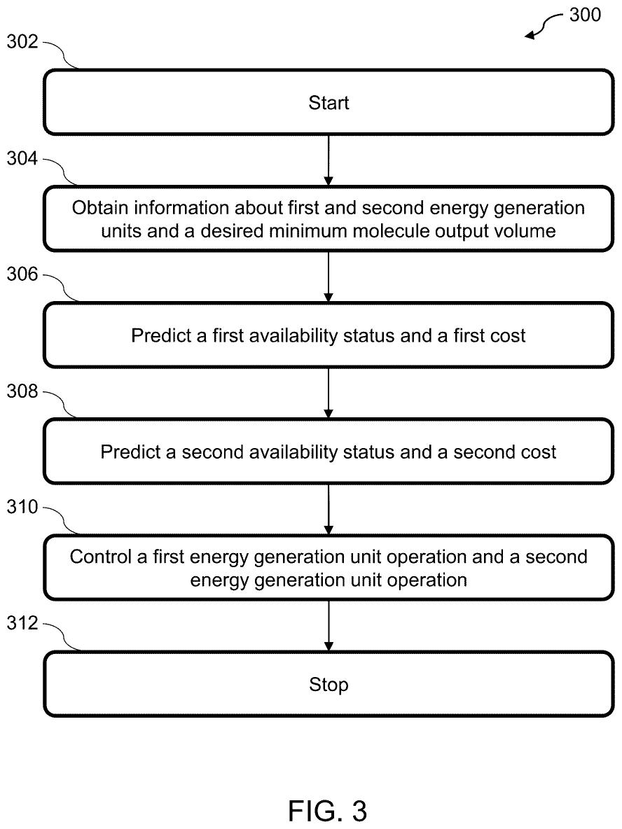

FIG. 3 depicts a flow diagram of an example method 300 for operating the system 102 in accordance with the present disclosure. FIG. 3 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 300 starts at step 302. At step 304, the method 300 may include obtaining, by the controller 104/processor 124, the first information associated with the first energy generation unit 110, the second information associated with the second energy generation unit 112, and the information associated with the desired minimum molecule output volume, as described above in conjunction with FIGS. 1 and 2.

At step 306, the method 300 may include predicting, by the controller 104, the first availability status associated with the first energy source and the first cost required to operate the first energy generation unit 110 based on the first information. At step 308, the method 300 may include predicting, by the controller 104, the second availability status associated with the second energy source and the second cost required to operate the second energy generation unit 112 based on the second information.

At step 310, the method 300 may include controlling, by the controller 104, the first energy generation unit operation and the second energy generation unit operation based on the first availability status, the first cost, the second availability status, the second cost and the desired minimum output volume. The process of controlling the first and second energy generation unit operations is described above in conjunction with FIGS. 1 and 2.

At step 312, the method 300 stops.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A microgrid system comprising:
a first energy generation unit configured to generate energy by using a first energy source;
a second energy generation unit configured to generate energy by using a second energy source;
a molecule generation unit configured to generate a molecule by using energy obtained from at least one of the first energy generation unit or the second energy generation unit; and
a controller configured to:
obtain a first information associated with the first energy generation unit, a second information associated with the second energy generation unit, and an information associated with a desired minimum output volume of the molecule from the molecule generation unit;
predict a first availability status associated with the first energy source and a first cost required to operate the first energy generation unit based on the first information;
predict a second availability status associated with the second energy source and a second cost required to operate the second energy generation unit based on the second information; and
control a first energy generation unit operation and a second energy generation unit operation based on the first availability status, the first cost, the second availability status, the second cost and the desired minimum output volume.

2. The microgrid system of claim 1, wherein the first energy source comprises one or more of an electrostatic energy and a molecular energy.

3. The microgrid system of claim 1, wherein the first energy source is an energy source comprising at least one of an electrostatic storage device, grid delivered power, a wind power generator, a solar power generator, a geothermal power generator, a natural gas powered turbine power generator, and a natural gas hydrogen blend powered turbine power generator.

4. The microgrid system of claim 1, wherein the second energy source comprising at least one of an electrostatic storage device, grid delivered power, a wind power generator, a solar power generator, a geothermal power generator, a natural gas powered turbine power generator, and a natural gas hydrogen blend powered turbine power generator.

5. The microgrid system of claim 1, wherein the molecule generation unit is an electrolysis unit configured to generate hydrogen.

6. The microgrid system of claim 5 further comprising a water source configured to supply water to the electrolysis unit to enable hydrogen generation.

7. The microgrid system of claim 1, wherein the molecule generation unit is an air separation unit configured to generate oxygen, nitrogen, and argon.

8. The microgrid system of claim 1, wherein the molecule generation unit is an air carbon capture device configured to separate CO2 from a natural gas power generator.

9. The microgrid system of claim 1, wherein the first information comprises at least one of a first real-time information, a first historical information, and a first forecast information associated with the first energy generation unit, and wherein the second information comprises at least one of a second real-time information, and a second forecast information, a second historical information associated with the second energy generation unit.

10. The microgrid system of claim 9, wherein:
the first real-time information is associated with a real-time availability status associated with the first energy source and a real-time cost required to operate the first energy generation unit,
the first historical information is associated with a historical availability status associated with the first energy source and a historical cost required to operate the first energy generation unit,
the second real-time information is associated with a real-time availability status associated with the second energy source and a real-time cost required to operate the second energy generation unit,
the second historical information is associated with a historical availability status associated with the second energy source and a historical cost required to operate the second energy generation unit,
the first forecast information is associated with predicted future information associated with the first energy source determined based on one or more of weather information, market pricing information, energy demand information, and current event information, and
the second forecast information is associated with predicted future information associated with the second energy source determined based on one or more of weather information, market pricing information, energy demand information, and current event information.

11. The microgrid system of claim 1, wherein the controller is further configured to:
determine an optimal first energy portion to be transferred to the molecule generation unit via the first energy generation unit and an optimal second energy portion to be transferred to the molecule generation unit via the second energy generation unit, based on the first information, the second information and the desired minimum output volume, wherein the controller determines the optimal first energy portion and the optimal second energy portion to minimize a cost of operating the microgrid system and enable the molecule generation unit to generate the desired minimum output volume of the molecule; and
control the first energy generation unit operation and the second energy generation unit operation based on the optimal first energy portion and the optimal second energy portion.

12. The microgrid system of claim 11, wherein the controller controls the first energy generation unit operation and the second energy generation unit operation by activating or deactivating at least one of the first energy generation unit or the second energy generation unit.

13. The microgrid system of claim 11, wherein the controller controls the first energy generation unit operation and the second energy generation unit operation by ramping up or ramping down a flow of energy from at least one of the first energy generation unit or the second energy generation unit to the molecule generation unit.

14. The microgrid system of claim 1, wherein the controller is further configured to:
obtain an information associated with a real-time molecule sale price; and
control the first energy generation unit operation and the second energy generation unit operation based on the real-time molecule sale price.

15. The microgrid system of claim 1, wherein the molecule generation unit is further configured to generate the molecule by using a grid power obtained from a utility grid, and wherein the controller is further configured to:
determine a purchase cost associated with the grid power; and
control a flow of grid power to the molecule generation unit based on the purchase cost.

16. The microgrid system of claim 15 further comprising an energy storage unit configured to store excess energy generated by at least one of the first energy generation unit or the second energy generation unit, wherein the controller is further configured to enable a flow of excess energy from the energy storage unit to the utility grid.

17. The microgrid system of claim 16, wherein the controller is further configured to:
obtain an information associated with a real-time energy sale price to the utility grid; and
control at least one of the flow of excess energy from the energy storage unit to the utility grid, the first energy generation unit operation or the second energy generation unit operation based on the real-time energy sale price to the utility grid.

18. The microgrid system of claim 16, wherein the molecule generation unit is further configured to generate the molecule by using energy obtained from the energy storage unit.

19. The microgrid system of claim 1, wherein the controller obtains the first information, the second information, and the information associated with the desired minimum output volume from an external server or a user device.

20. The microgrid system of claim 1 further comprising a molecule storage unit configured to store the molecule generated by the molecule generation unit.

21. A microgrid system comprising:
a first energy generation unit configured to generate energy using a first energy source comprising one of a natural gas, and a hydrogen and a natural gas hydrogen blend;
a second energy generation unit configured to generate energy by using a second energy source comprising one of a natural gas, and a hydrogen and a natural gas hydrogen blend;
a molecule generation unit configured to generate a molecule by using energy obtained from at least one of the first energy generation unit or the second energy generation unit; and
a controller configured to:
obtain a first information associated with the first energy generation unit, a second information associated with the second energy generation unit, and an information associated with a desired minimum output volume of the molecule from the molecule generation unit;
predict a first availability status associated with the first energy source and a first cost required to operate the first energy generation unit based on the first information;
predict a second cost required to operate the second energy generation unit based on the second information; and
control a first energy generation unit operation and a second energy generation unit operation based on the first availability status, the first cost, the second cost and the desired minimum output volume.

22. A method to operate a microgrid system, the method comprising:
obtaining, by a controller, a first information associated with a first energy generation unit, a second information associated with a second energy generation unit, and an information associated with a desired minimum output volume of a molecule from a molecule generation unit, wherein:
the first energy generation unit is configured to generate energy by using a first energy source,
the second energy generation unit is configured to generate energy by using a second energy source, and
the molecule generation unit is configured to generate the molecule by using energy obtained from at least one of the first energy generation unit or the second energy generation unit;
predicting, by the controller, a first availability status associated with the first energy source and a first cost required to operate the first energy generation unit based on the first information;
predicting, by the controller, a second availability status associated with the second energy source and a second cost required to operate the second energy generation unit based on the second information; and
controlling, by the controller, a first energy generation unit operation and a second energy generation unit operation based on the first availability status, the first cost, the second availability status, the second cost and the desired minimum output volume.
